(19) United States
(12) Patent Application Publication
(10) Pub. No.: US 2013/0066840 A1
(43) Pub. Date: Mar. 14, 2013

(54) METHOD AND APPARATUS FOR RESOLVING INCOHERENT DATA ITEMS

(71) Applicants: Eric Anthony Silva, Somerville, MA (US); Hans Peter Brondmo, San Francisco, CA (US); Jacob Barss-Bailey, Cambridge, MA (US)

(72) Inventors: Eric Anthony Silva, Somerville, MA (US); Hans Peter Brondmo, San Francisco, CA (US); Jacob Barss-Bailey, Cambridge, MA (US)

(21) Appl. No.: 13/558,849

(22) Filed: Jul. 26, 2012

Related U.S. Application Data
(60) Provisional application No. 61/513,636, filed on Jul. 31, 2011.

(51) Int. Cl. G06F 17/30

(52) U.S. Cl. 707/690; 707/E17.005

(57) ABSTRACT

An approach is provided for resolving incoherent data items of a user spanning multiple different groups and/or services. An incoherency platform determines an incoherency of a first data item and at least a second data item that are shared by a first user in a first group and at least a second group, respectively. The platform also processes the incoherency, the first data item, the at least a second data item, or a combination thereof to cause, at least in part, a generation of a resolved data item. The platform further causes, at least in part, a substitution of the resolved data item for the first data item, the at least a second data item, or a combination thereof.

### RELATED APPLICATIONS

This application claims benefit of the earlier filing date under 35 U.S.C. §119(e) of U.S. Provisional Application Ser. No. 61/513,636 filed Jul. 31, 2011, entitled “Method and Apparatus for Resolving Incoherent Data Items,” the entirety of which is incorporated herein by reference.

### BACKGROUND

Service providers and device manufacturers (e.g., wireless, cellular, etc.) are continually challenged to deliver value and convenience to consumers by, for example, providing compelling network services. One area of interest has been sharing information with other users via a communication network. Such interest has lead many service providers to form social networking services. These social networking services allow users to share information regarding themselves with the public and/or groups of friends, family, co-workers, etc. A specific service provided by these social networking services includes allowing users to broadcast their status information, such as their current location and/or current activity. However, users often belong to more than social networking service and/or, within each social networking service, belong to more than one group. Thus, a problem arises concerning incoherent data items among multiple social networking services or within the same social networking service but among multiple different groups. This problem is aggravated when other users belong to the same social networking services or the same groups such that the users are aware of the incoherency. Balanced with this problem, however, is the concept that some incoherent data items are intentional based on a user limiting the information one group receives as compared to another group. Therefore, service providers and device manufacturers face significant technical challenges in resolving incoherencies between data items of a user spanning multiple different services and/or groups while maintaining the intention of a user in controlling information.

### SOME EXAMPLE EMBODIMENTS

Therefore, there is a need for an approach for resolving incoherent data items of a user spanning multiple different groups and/or services.

According to one embodiment, a method comprises determining a first user and at least a second user that are associated with a first group and at least a second group. The method also comprises determining an incoherency of a first data item that is shared by the first user in the first group and is accessible by the at least a second user, and at least a second data item that is shared by the first user in the at least a second group and is accessible by the at least a second user. The method further comprises processing and/or facilitating a processing of the incoherency, the first data item, the at least a second data item, or a combination thereof to cause, at least in part, a generation of a resolved data item.

According to another embodiment, an apparatus comprises at least one processor, and at least one memory including computer program code for one or more computer programs, the at least one memory and the computer program code configured to, with the at least one processor, cause, at least in part, the apparatus to determine a first user and at least a second user that are associated with a first group and at least a second group. The apparatus is also caused to determine an incoherency of a first data item that is shared by the first user in the first group and is accessible by the at least a second user, and at least a second data item that is shared by the first user in the at least a second group and is accessible by the at least a second user. The apparatus is further caused to process and/or facilitate a processing of the incoherency, the first data item, the at least a second data item, or a combination thereof to cause, at least in part, a generation of a resolved data item.

According to another embodiment, a computer-readable storage medium carries one or more sequences of one or more instructions which, when executed by one or more processors, cause, at least in part, an apparatus to determine a first user and at least a second user that are associated with a first group and at least a second group. The apparatus is also caused to determine an incoherency of a first data item that is shared by the first user in the first group and is accessible by the at least a second user, and at least a second data item that is shared by the first user in the at least a second group and is accessible by the at least a second user. The apparatus is further caused to process and/or facilitate a processing of the incoherency, the first data item, the at least a second data item, or a combination thereof to cause, at least in part, a generation of a resolved data item.

According to another embodiment, an apparatus comprises means for determining a first user and at least a second user that are associated with a first group and at least a second group. The apparatus also comprises means for determining an incoherency of a first data item that is shared by the first user in the first group and is accessible by the at least a second user, and at least a second data item that is shared by the first user in the at least a second group and is accessible by the at least a second user. The apparatus further comprises means for processing and/or facilitating a processing of the incoherency, the first data item, the at least a second data item, or a combination thereof to cause, at least in part, a generation of a resolved data item.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-20, 41-60, and 86-88.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of resolving incoherent data items of a user spanning multiple different groups and/or services, according to one embodiment;

FIG. 2 is a diagram of the components of an incoherency platform, according to one embodiment;

FIG. 3 is a flowchart of a process for resolving incoherent data items of a user spanning multiple different groups and/or services, according to one embodiment;

FIGS. 4A-4H are diagrams of user interfaces utilized in the processes of FIG. 3, according to various embodiments;

FIG. 5 is a diagram of hardware that can be used to implement an embodiment of the invention;

FIG. 6 is a diagram of a chip set that can be used to implement an embodiment of the invention; and

FIG. 7 is a diagram of a mobile terminal (e.g., handset) that can be used to implement an embodiment of the invention.

### DESCRIPTION OF SOME EMBODIMENTS

Examples of a method, apparatus, and computer program for resolving incoherent data items of a user spanning multiple different groups and/or services are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

As used herein, the term data item refers to any information that describes and/or is associated with information regarding a user, a group of users, or a combination thereof that is accessible through a communications network. Although various embodiments are described below with respect to data items corresponding to status updates of a user's location, it is contemplated that the approach described herein may be used with other type of data items. Further, although various embodiments are described below with respect to social networking services, it is contemplated that the approach described herein may be used with any type of service that provides data items.

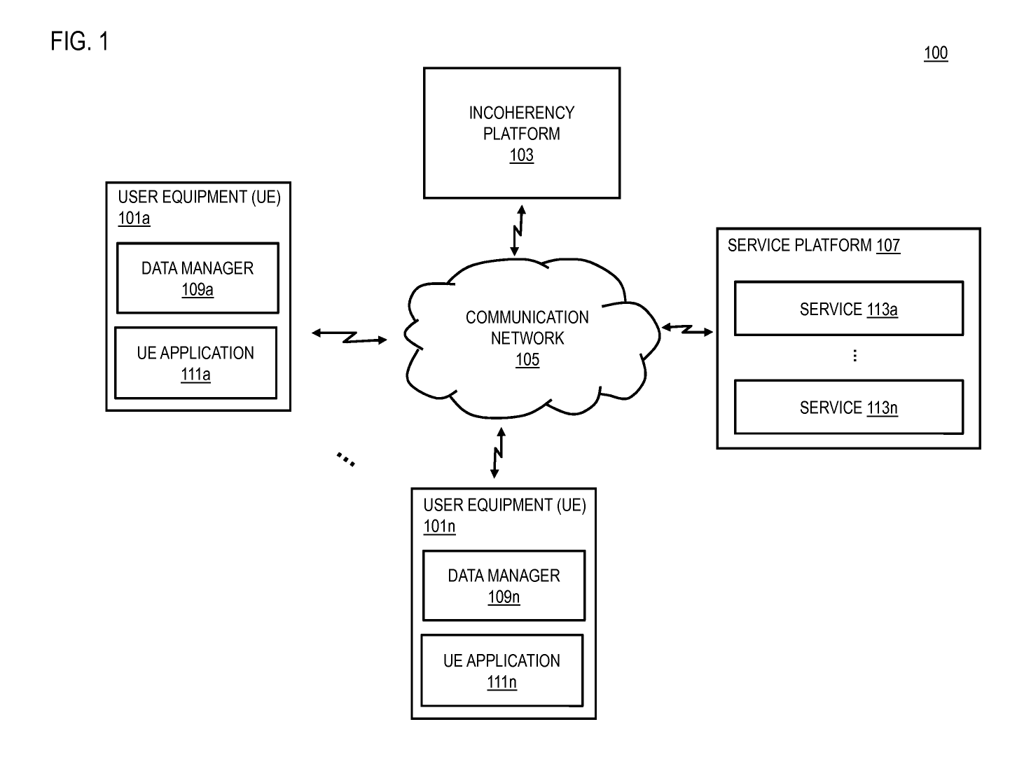

FIG. 1 is a diagram of a system capable of resolving incoherent data items of a user spanning multiple different groups and/or services, according to one embodiment. As discussed above, many users participate is social networking services. Participating in such services often involves providing data items to complete profile information. Such data items may include the user's date of birth, hometown, favorite music, favorite books, favorite movies, favorite television shows, job information and/or any other information that is associated with the user. The user can often join groups within a social networking service and can provide additional information that is associated with the user and the particular group. By way of example, social networking services often allow users to post information regarding their current status, such as activities the users are currently participating in, locations the users are currently at, etc. Further, such current status information can be associated with a particular group such that members of the group can see the status information. Often, users that are not associated with the group cannot see the status information.

As the number of social networking services and groups within the services increases, as well as the amount of information that can be associated with the users, incoherent data items associated with a user among different social networking services and/or groups within the social networking services become an issue. By way of example, User A and User B both belong to Group 1 and Group 2 within a social networking service. One morning, User A posts to Group 1 the message “8:00 AM—Getting coffee in Cambridge, Mass.” Further, User A then posts to Group 2 the message “10:00 AM—At the office in Boston, Mass.” For users of Group 1 who are not members of Group 2, as well as members of Group 2 who are not members of Group 1, there is no apparent incoherency regarding the status of User 1 because the users can only see one of the statuses. However, for User B, who is a member of both Group 1 and Group 2, there is an incoherency among the current status of User A. User B cannot be sure whether User A is getting coffee in Cambridge, Mass. or at the office in Boston, Mass. This issue is aggravated as the number of users who participate in the same social networking services and/or groups within the services increases as well as the number of incoherent data items increases.

Balanced with the issue of incoherent data items, however, is the concept that some incoherent data items are intentionally incoherent because a user wants to control the information received by members of one social networking service or group as compared to another social networking service or group. By way of example, User A may belong to Group 1 comprised of co-workers and Group 2 comprised of friends. User A may post the message “12:00 PM—Dentist appointment in Chicago, Ill.” to Group 1 for the co-workers to see. However, after the dentist appointment and prior to returning to work, User A have an extended lunch with a friend and consequently post the message “1:00 PM—Lunch with Steve at Carmine's in Chicago, Ill.” to Group 2 for the friends to see. Thus, User A does not want the co-workers who are not members of Group 2 (e.g., not also friends of User A) to see that User A is taking an extended lunch. In this situation, the incoherent data items (e.g., status updates) are intentional and the user may not want to resolve the incoherent data items, or at least not resolve the incoherent data items to the extent that the co-workers of Group 1 realize that User A is taking an extended lunch after the dentist's appointment.

To address these problems, a system 100 of FIG. 1 introduces the capability to resolve incoherent data items of a user spanning multiple different groups and/or services. According to one embodiment, the system 100 determines a first user and at least a second user that are associated with a first group and at least a second group. The groups can be any grouping of entities, either associated with a single social networking service or spanning multiple different social networking services. Additionally, there can be more than two users (e.g., hundreds, thousands, etc.) of users that share at least two groups in common. By way of example, in reference to the example discussed above, the system 100 determines that User A is a member of Group 1 and Group 2, and that User B also is a member of Group 1 and Group 2.

Then system 100 further determines an incoherency of a first data item that is shared by the first user in the first group and is accessible by the at least a second user, and at least a second data item that is shared by the first user in the at least a second group and is accessible by the at least a second user. By way of example, User A broadcasts a status update message with respect to Group 1 of “12:00 PM—Dentist appointment in Chicago, Ill.” that is viewable by User B. User A also broadcasts a status update message with respect to Group 2 of “1:00 PM—Lunch with Steve at Carmine's in Chicago, Ill.” that also is viewable by User B. These exemplary data items are incoherent because the first data item implies User A is at the dentist and the second data item implies that User A is getting lunch with a friend at a restaurant, even despite the temporal information associated because no changes to the statuses have been broadcast within each group.

The system 100 further processes the incoherency, the first data item, the at least a second data item, or a combination thereof to cause, at least in part, a generation of a resolved data item, and substitutes the resolved data item for the first data item, the at least a second data item, or a combination thereof. The resolved data item is, for example, information that can be substituted with one of the first data item, the second data item, or both data items to resolve the incoherency between the two data items. Under one approach, by way of example, the resolved data item may constitute “1:00 PM—In Chicago, Ill.” and substitute the status update for Group 1 associated with User A to inform the members of Group 1 of a status update occurring at 1:00 PM and that User A is somewhere in Chicago, Ill. This status update can be based on the status update associated with Group 2. Such a status update apprises the members of Group 1 of the change in the status of User A, but maintains a level of privacy by being a lower level of granularity than the status update for Group 2. For example, rather than including a time (e.g., 1:00 PM), subject (Lunch with Steve) and location (e.g., Carmine's in Chicago, Ill.), the resolved data item merely includes a time and a general location (e.g., Chicago, Ill.).

Under another approach, the resolved data item may constitute “1:00 PM—Lunch with Steve at Carmine's in Chicago, Ill.” and may substitute the status update for Group 1 associated with User A only for users that are members of both Group 1 and Group 2, such as User B. Thus, when User B views the status update of User A for Group 1, User B sees the message “1:00 PM—Lunch with Steve at Carmine's in Chicago, Ill.,” which is no longer incoherent with the status update of User A for Group 2. However, if User C, who is member of Group 1 but not Group 2, views the status update of User A for Group 1, User C still sees the message “12:00 PM—Dentist appointment in Chicago, Ill.” because User C is not a member of Group 2 and is therefore unaware of the incoherency of the status update. Under this approach, the incoherency is resolved while maintaining any intended privacy.

As shown in FIG. 1, the system 100 comprises user equipment (UEs) 101a-101n (collectively referred to as UEs or UE 101) having connectivity to an incoherency platform 103 via a communication network 105. The UE 101 and the incoherency platform 103 may also have connectivity to a service platform 107. The UE 101 may include a data manager 109 (e.g., respective data managers 109a-109n of the UEs 101a-101n) that communicates with the incoherency platform 103 to resolve incoherent data items related to any UE 101 and/or any user of the UE 101. The incoherency platform 103 may exist independently, or within the UE 101, or within the service platform 107. The incoherency platform 103 may be used to resolve incoherent data items upon a request for one or more of the data items from an application. The application may be a UE application 111 (e.g., UE applications 111a-111n), which may include various types of software applications in the UE 101. By way of example, if the user device is the UE 101a, the application that requests a data item may be the UE application 111a or an application of another device such as the UE application 111n of the UE 101n. The incoherency application also may be used to resolve incoherent data items upon a request from a service (e.g., upon a request from a UE application 111 to a service to provide the data of the service to the UE 101). The services that request data items and/or provide the data items may include at least one of the services 113a-113n (collectively referred to as services 113) in the service platform 107, which are accessible via the communication network 105. The services 113 can include, for example, one or more social networking services.

In one embodiment, where the substitution of a first data item occurs because of the incoherency of the first data item with a second data item, with the first data item and the second data item associated with a first group and a second group, respectively, the substitution applies to the first group, the second group, or a combination thereof. By way of example, the substitution of the first data item with a resolved data item may apply only to the first group, such that users of the second group are unaware of the substitution. Alternatively, the substitution of the first data item with the resolved data item may apply to both the first group and the second group.

In one embodiment, the incoherency platform 103 determines temporal information associated with the data items and processes the temporal information to generate a resolved data item. Specifically, the incoherency platform 103 determines a most recent data item or a least recent data item among two or more incoherent data items. Based on this determination, the incoherency platform 103 can determine how to generate the resolved data item. By way of example, if a first data item was entered by a user at a later time than a more recent second data item that creates an incoherency with the first data item, the incoherency platform 103 determines to resolve the incoherency by generating the resolved data item based on the more recent, second data item.

Similarly, in one embodiment, the incoherency platform 103 determines the temporal information associated with the data items and processes the temporal information to determine which data item to substitute. Specifically, the incoherency platform 103 determines a most recent data item or a least recent data item among two or more incoherent data items. Based on this determination, the incoherency platform 103 can determine the data item to substitute with the resolved data item.

In one embodiment, the incoherency platform 103 determines a level of granularity of the data items. The level of granularity may represent a level of detail, in one example. In another example, the level of granularity may also represent a hierarchy of information. Further, in another example, the level of granularity may be related to types of information. In one embodiment, the incoherency platform 103 provides one or more mechanisms to determine the level of granularity of the data items. The mechanism may be made up of rules and/or equations to determine the level of granularity. By way of example, a first data item corresponding to a location of a user that includes a city and a state within the United States corresponds to one level of granularity. A second data item corresponding to a location of a user that includes only a state within the United States corresponds to another level of granularity, which is lower than the level of granularity of the first data item. A third data item corresponding to a specific intersection within a city and a state within the United States corresponds to another level of granularity that is higher than both the first level and the second level. In one embodiment, the incoherency platform 103 prompts the user for resolved data item information that can include, at least in part, a target level of granularity. Thus, the incoherency platform 103 allows a user whose data items are incoherent to control the granularity of the resolved data item used to resolve the incoherency.

In one embodiment, after determining the level of granularity of the data items, the incoherency platform 103 processes the level of granularities to determine a target level of granularity that is used to generate the resolved data item. By way of example, for a data item of “8:00 AM—Getting coffee in Chicago, Ill.,” the level of granularity may be reduced to remove the subject of the data item (e.g., getting coffee) and keep only the location of the data item (e.g., Chicago, Ill.). Thus, the target level of granularity is lower than the level of granularity of the data item from which the resolved data item is based.

In one embodiment, the incoherency platform 103 creates at least one index of data items according, at least in part, to users that the data items are associated with, groups and/or services that the data items are associated with, and other users of the groups and/or services that the data items are associated with. Based on the at least one index, the incoherency platform 103 can quickly determine relationships between users, groups and/or services, and data items to determine incoherent data items and the actions to take to correct the incoherencies. In one embodiment, the incoherency platform 103 determines the incoherency among at least two or more data items based on a brute force approach.

By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the UE 101, the incoherency platform 103 and the service platform 107 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

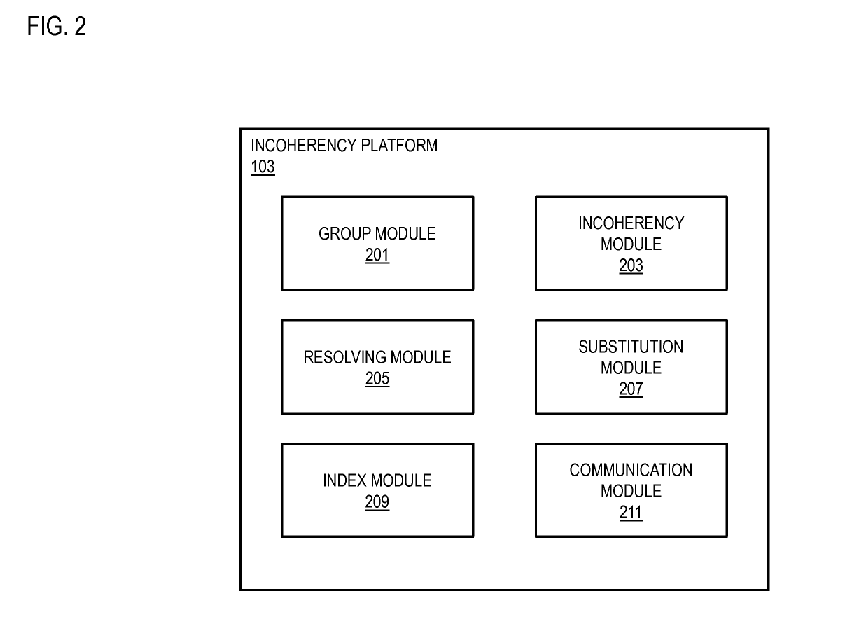

FIG. 2 is a diagram of the components of the incoherency platform 103, according to one embodiment. By way of example, the incoherency platform 103 includes one or more components for resolving incoherent data items of a user spanning multiple different groups and/or services. It is contemplated that the functions of these components may be combined in one or more components or performed by other components of equivalent functionality. In this embodiment, the incoherency platform 103 includes a group module 201, an incoherency module 203, a resolving module 205, a substitution module 207, an index module 209 and a communication module 211.

The group module 201 tracks the services and/or groups that users are associated with. In one embodiment, where the incoherency platform 103 spans multiple different services (e.g., multiple social networking services), the group module 201 treats the different services as different groups. The group module 201 determines the users that are associated with each one of the different services. In one embodiment, where the incoherency platform 103 serves a single service (e.g., a single social networking service), the group module 201 tracks the number of groups within the service and the users that are associated with each one of the different groups. In one embodiment, where the incoherency platform 103 spans multiple different services (e.g., multiple social networking services) and there are one or more groups associated with one or more of the services, the group module 201 treats the services as groups and the one or more groups within each service as subgroups of the groups. The group module 201 determines the users that are associated with each group (e.g., service) and each subgroup (e.g., group within a service).

The incoherency module 203 determines whether two or more data items are incoherent. In one embodiment, the incoherency module 203 determines if two or more data items are related to comparable data items for the same user and/or group of users. For example, if data item 1 is related to a user's date of birth and data item 2 is related to a user's hair color, data item 1 and data item 2 cannot be incoherent because they are not comparable data items. In other words, data item 1 will never conflict with data item 2. However, if data item 1′ is related to a user's status and data item 2′ also is related to a user's status, data item 1′ and data item 2′ can be incoherent since they concern the same subject matter (e.g., the user's status).

The incoherency module 203 then determines, for comparable data items, whether two or more data items associated with a user and/or a group of users are incoherent. The incoherency module 203 determines whether two or more data items are incoherent using, for example, one or more comparison algorithms that extract the information from within the two or more data items and compare the information to each other. In one embodiment, any difference between two or more data items associated with a user and/or a group of users corresponds to an incoherency. In one embodiment, a difference above a threshold difference corresponds to an incoherency. By way of example, in one embodiment, there may be no incoherency between the data items represented by “biking to work today” and “biked to work today” because both data items represent essentially the same message meaning. In one embodiment, there may be an incoherency based on the strict difference between the two messages (e.g., the word biking is not the word biked). In one embodiment, there may be an incoherency based on the difference in the meanings of the two messages (e.g., “biking” in the process of completing versus “biked” already completed). The determination of whether or not there is an incoherency can be set by, for example, the provider of the incoherency platform 103, a user of the incoherency platform 103, and/or a service 113 using the incoherency platform 103.

The resolving module 205 generates the resolved data item that is substituted for one or more of the incoherent data items. In one embodiment, the resolving module 205 processes one or more incoherent data items to generate the resolved data item. The resolving module 205 processes the one or more incoherent data items to generate a resolved data item that, when substituted for one or more of the incoherent data items, resolves the incoherency. The resolved data item can resolve the incoherency completely or at least in part. By way of example, if incoherent data items are “Bowling in Chicago, Ill.” and “Dancing in Oak Brook, Ill.,” the resolved data item can completely resolve the incoherency by replacing “Bowling in Chicago, Ill.” with “Dancing in Oak Brook, Ill.” Alternatively, the resolved data item can resolve the incoherency, at least in part, by replacing “Bowling in Chicago, Ill.” with “in Oak Brook, Ill.” Thus, at least the two data items are coherent with respect to the location of the user.

Related to the completeness of correcting the incoherency, in one embodiment, the resolving module 205 determines the level of granularity of the two or more data items to generate the resolved data item. As discussed above, the level of granularity may represent a level of detail, a hierarchy of information, types of information, etc. The resolving module 205 provides one or more mechanisms for determining the level of granularity of the data items. The mechanisms may be made up of rules and/or equations to determine the level of granularity. By way of example, for the same type of information, a first data item corresponding to a location of a user that includes a city and a state within the United States corresponds to a medium level of granularity. Further, a second data item corresponding to a location of a user that includes only a state within the United States corresponds to low level of granularity. A third data item corresponding to a specific intersection within a city and a state, and within the United States, corresponds to high level of granularity. By way of further example, for different types of information, a first data item that includes information regarding an activity, a location and a time has a higher level of granularity than a second data item that includes information regarding only the location.

The resolving module 205 determines a target level of granularity based on one or more levels of granularity of the one or more data items. The target level of granularity is, for example, a level of granularity for the resolved data element. In one embodiment, the level of granularity for the resolved data element is the same, or substantially similar, to the level of granularity of the data item that the resolved data item is based on. By way of example, if the resolved data item is based on a data item corresponding to a granularity of a specific date and time, such as “Nov. 21, 1979—8:25 AM,” and the target level of granularity is the same as the data item, the resolved data item would also have a granularity of a specific date and time, such as “Sep. 13, 1976—11:00 PM.” In one embodiment, the level of granularity for the resolved data item is less than the level of granularity of the data item that the resolved data item is based on. For the above example, the resolved data item would have a granularity of “Sep. 13, 1976” or “September 1976.”

The target level of granularity allows the incoherency platform 103 to substitute the resolved data item for a data item that has the same as or a lower than level of granularity to control the amount of information that other users are able to view. In one embodiment, the resolving module 205 determines to have multiple different levels of granularity for multiple different resolved data items such that different users associated with different groups and/or services view resolved data items of varying levels of granularity. In one embodiment, the resolving module 205 prompts the user whose data items are incoherent for resolved data item information that can include, in part, a target level of granularity. Thus, in one embodiment, the resolving module can determine the target level of granularity, at least in part, based on an input from the user. By controlling the target level of granularity through the resolved date item information, a user can control the visibility of data items and therefore further control the privacy of the information contained in the data items while at the same time resolving incoherent data items.

The substitution module 207 substitutes the resolved data item generated by the resolving module 205 with one or more of the data items that are incoherent. In one embodiment, the substitution module 207 replaces the substituted data item with the resolved data item. In one embodiment, the substitution module 207 inserts merely portions of the resolved data item into the one or more substituted data items such that the data items are not entirely replaced by the resolved data item.

The substitution module 207 also determines which users are able to view the resolved data item. In other words, the substitution module 207 determines whether the substitution of the resolved data item for one of the incoherent data items applies to a user. In one embodiment, the substitution module 207 applies the substitution to the user whose data item is being resolved, to a user who is associated with the at least two groups that are associated with the incoherent data items, to members of one of the groups that are associated with the resolved data item, to members of the groups that are associated with the other data items, or a combination thereof.

In one embodiment, the index module 209 creates at least one index that is used to determine the incoherency of the one or more data items. In one embodiment, the index module 209 determines one or more services that are associated with the incoherency platform 103. The one or more services are associated with the incoherency platform 103 if, for example, one or more users of the services have data items that can be determined as being incoherent. The index module 209 further determines one or more groups associated with respective one or more of the services. The index module 209 further determines one or more users that are associated with the one or more groups. The index module 209 further determines one or more data items that are associated with the one or more users. Upon compiling the foregoing information, the index module 209 determines one or more links associated between one or more users among the one or more groups, the one or more services, or a combination thereof. Accordingly, the index module 209 is able to determine relationships between users and data items to perform the functions of the incoherency platform 103. In one embodiment, the index module 209 determines the relationships between users and data items based on a brute force approach without using an index.

The communication module 211 communicates with the UE 101 and the service platform 107 for resolving incoherent data items, such as for receiving requests to resolve incoherent data items from a service 113 on the service platform 107 in response to a user accessing one or more data items. The communication module 211 also communicates with the UE 101 of a user whose associated data items are incoherent to, for example, notify the user of the incoherent data items, notify the user of the substitution of a resolved data item for one or more data items, and/or prompt the user for inputs such as resolved data item information. By way of example, upon the incoherency module 203 determining an incoherency between at least two data items, the incoherency module 203 can interface with the communication module 211 to communicate the incoherency with the user whose data items are incoherent. Further, upon the substitution module 207 substituting one or more of a user's incoherent data items with a resolved data item, the substitution module 207 can interface with the communication module 211 to communicate the substitution with the user whose data items are incoherent. In one embodiment, when communicating with the UE 101, the communication module 211 creates and/or controls the user interfaces displayed at the UE 101.

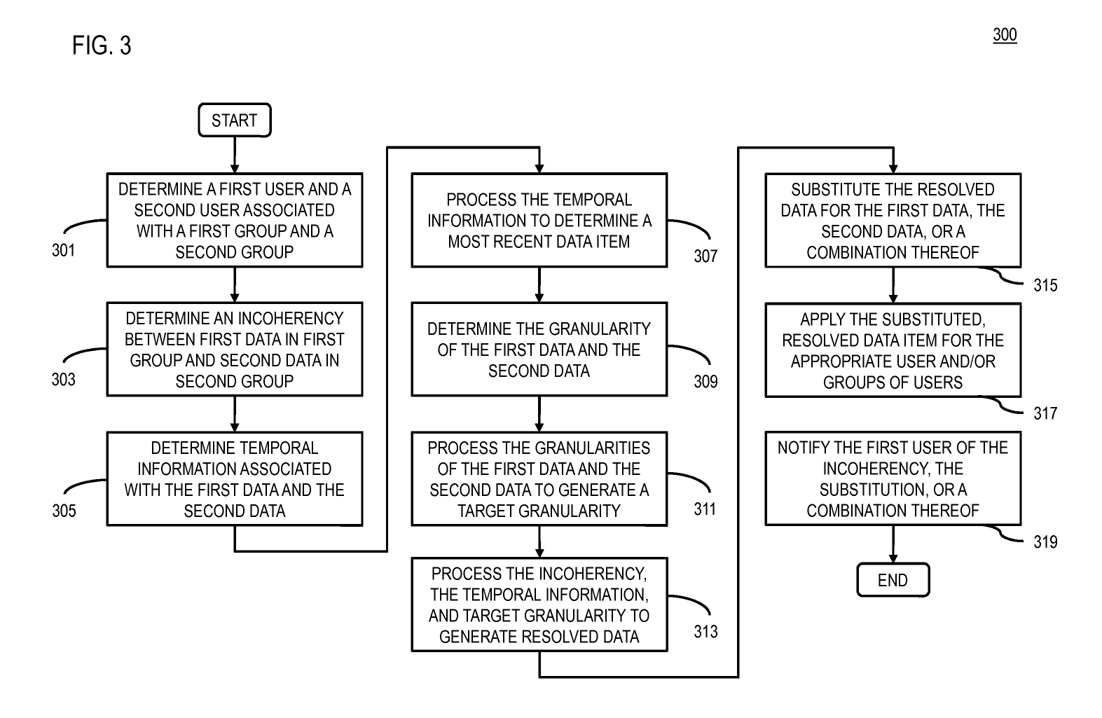

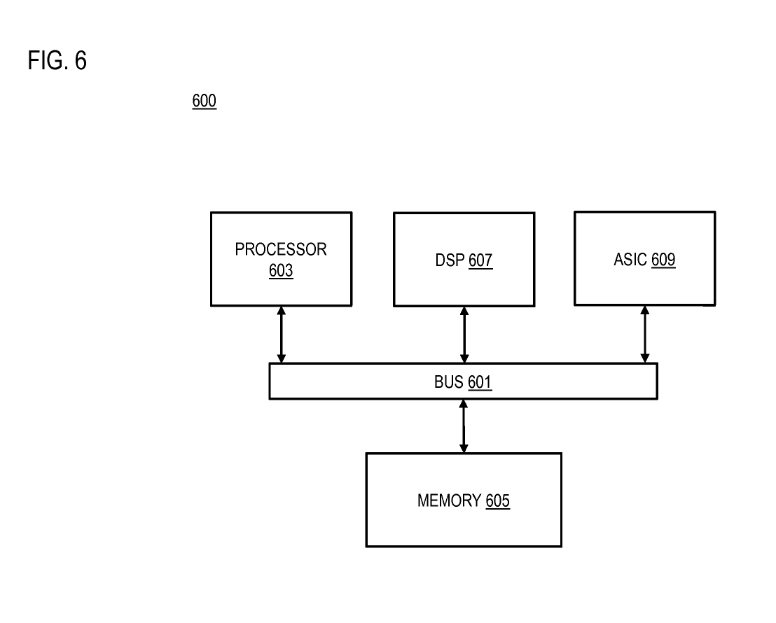

FIG. 3 is a flowchart of a process for resolving incoherent data items of a user spanning multiple different groups and/or services, according to one embodiment. In one embodiment, the incoherency platform 103 performs the process 300 and is implemented in, for instance, a chip set including a processor and a memory as shown in FIG. 6. In step 301, the incoherency platform 103, after receiving a request to determine incoherency of one or more data items, determines a first user and a second user that are associated with a first group (or service) and a second group (or service). By way of example, the first user belongs to Group 1 and Group 2 and the second user belongs to Group 1 and Group 2, both of which are groups of a social networking service. In one embodiment, Group 1 and Group 2 may be associated with different social networking services or may not be groups but instead be different social networking services.

A step 303, the incoherency platform 103 determines an incoherency between a first data item that is shared by the first user and a second data item that also is shared by the first user. Additionally, the second user is able to access the first data item and the second data item because, for example, the second user is a member of the first group and the second group. An incoherency exists between the first data item and the second data item based on, for example, there existing a difference between the subjects of the data items despite the data items being based on comparable items.

In one embodiment, at step 305 the incoherency platform 103 determines temporal information associated with the first data item and the second data item. In one embodiment, the temporal information corresponds to the time in which the user entered, updated, modified or otherwise changed the data items. By way of example, the temporal information associated with a data item in the form of a status update corresponds to the posting time (and date) of the status update.

In one embodiment, at step 307, the incoherency platform 103 processes the temporal information to determine a most recent data item between the first data item and the second data item. By way of example, if the first data item corresponds to a status update posted at 8:00 AM and the second data item corresponds to a status update posted at 10:00 AM, the incoherency platform 103 determines that the second data item is the most recent data item. In one embodiment, the incoherency platform 103 can process the temporal information to determine a least recent data item that, in effect, determines a most recent data item if there are only two incoherent data items.

In one embodiment, at step 309, the incoherency platform 103 determines the granularity of the first data item and the second data item. As discussed above, incoherency platform 103 uses one or more mechanisms to determine the level of granularity of the data items, which may be made up of rules and/or equations to determine the level of granularity.

In one embodiment, at step 311, the incoherency platform 103 determines a target level of granularity based on one or more levels of granularity of the first data item and the second data item. The target level of granularity is, for example, a level of granularity for the resolved data element. By way of example, if the target level of granularity is based on the most recent, second data item, the incoherency platform 103 determines the level of granularity of the second data item and bases the resolved data item on the level of granularity of the second data item. By way of example, if the second data item corresponds to a granularity of a specific date and time, such as “Nov. 21, 1979—8:25 AM,” a target level of granularity is determined based on this level of granularity. In one embodiment, the target level of granularity is based, at least in part, by a user of the incoherency platform 103, a service 113 using the incoherency platform 103, and/or a service 113 providing the incoherency platform 103. By way of example, a user can set the target level of granularity to be half the level of granularity of the data item with the highest level of granularity.

In one embodiment, the incoherency platform 103 does not determine a target level of granularity if, for example, the resolved data item is based solely on an exact copy of one of the incoherent data items. In one embodiment, the incoherency platform 103 determines the target level of granularity based on, for example, resolved data item information set by a user whose data items are incoherent. By way of example, the incoherency platform 103 can notify the user of incoherent data items and prompt the user for resolved data item information that, in part, includes information regarding the level of granularity of the resolved data item. Thus, the incoherency platform 103 allows the user to control the level of information other users are able to view while at the same type resolving incoherent data items.

At step 313, the incoherency platform 103 processes the incoherency, the temporal information, and the target level of granularity to generate resolved data. As discussed above in the first example, under one approach, a resolved data item may constitute “1:00 PM—In Chicago, Ill.” and substitute the first data item corresponding to the status update “12:00 PM—Dentist appointment in Chicago, Ill.” based on the level of granularity and temporal information of the second data item of the status update “1:00 PM—Lunch with Steve at Carmine's in Chicago, Ill.” In such an example, the incoherency between the first data item and the second data item is resolved, at least in part, based on the time of the resolved data item matching the time of the second data item (e.g., 1:00 PM). Further, the resolved data item is based on the second data item because the second data item was the most recent (e.g., 1:00 PM compared to 12:00 PM). Further, the level of granularity of the resolved data item is lower than the second data item because the resolved data item only describes the city and state that User A is in, not also the subject of the message. Thus, the appropriate resolved data item is created and a certain level of privacy is maintained because members of only Group are only aware of the new status as of 1:00 PM and are aware of the specific location at Carmine's.

Under another approach, the resolved data item may constitute “1:00 PM —Lunch with Steve at Carmine's in Chicago, Ill.” rather than “1:00 PM—In Chicago, Ill.” In such an approach, the incoherency of the first data item is resolved since the resolved data item is the same information as the second data item. In this approach, the level of granularity is not considered since the resolved data item has the same level of granularity as the second data item (e.g., the same level of information is in both the resolved data item and the second data item). In this instance, the most recent data item (e.g., the second data item) is still considered in generating the resolved data item (e.g., the resolved data item is based on “1:00 PM—Lunch with Steve at Carmine's in Chicago, Ill.”). Under this approach, the appropriate resolved data item is still created.

A step 315, the generated resolved data item is substituted for either the first data item or the second data item based on the above processing of the two data items. At step 317, the resolved data item is applied to the appropriate users and/or groups of users. In one embodiment, the resolved data item is only applied to users that are able to see both the first data item and the second data item—the users that belong to both the first group and the second group. In other words, the substituted, resolved data item is only visible to a user that would otherwise be able to see the incoherent data items and is not visible to users that would otherwise not be able to see the incoherent data items. In such an embodiment, the granularity of the substituted, resolved data item is the same as the data item that is not being substituted because, for example, the resolved data item is identical to the remaining data item. In this approach, a level of privacy is maintained by applying the resolved data item to only users that would be aware of the incoherency.

In one embodiment, the resolved data item is applied to both the first group and the second group such that any member of either one of the groups is able to view the resolved data item. In such an embodiment, the granularity of the resolved data item can be set to less than the level of granularity of the data item for which the resolved data item matches to correct the incoherency. In this approach, a level of privacy is maintained by not revealing all of the level of granularity to all of the users while maintaining, at least in part, coherent data items.

However, the approaches under either of the above-two examples can be swapped such the resolved data item is applied to all of the groups at the same level of granularity as the data item that the resolved data item is coherent with, or such that the resolved data item is applied to only members of both groups.

In one embodiment, at step 319, the user whose data items are incoherent can be notified of the incoherency of the data items, the substitution of one or more data items for the resolved data item, or a combination thereof. Although illustrated as occurring after steps 301-317, the incoherency platform 103 can notify the user of incoherent data items upon the user entering a data item that is incoherent with a previously entered data item. Thus, for example, after determining an incoherency in step 303, after the process 300 is initiated in response to the user entering a new data item, for example, the user may be notified that the new data item is incoherent with an existing data item. In one embodiment, as illustrated by step 319, the user whose data items are incoherent can be notified after a resolved data has already been substituted for one of the incoherent data items.

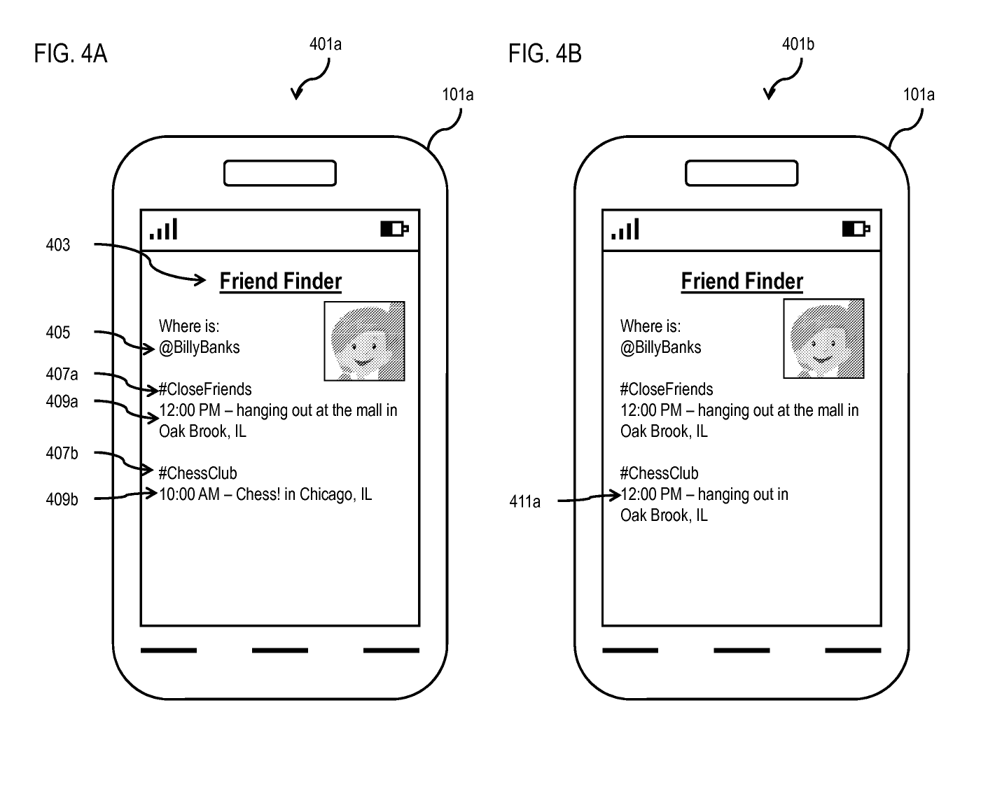

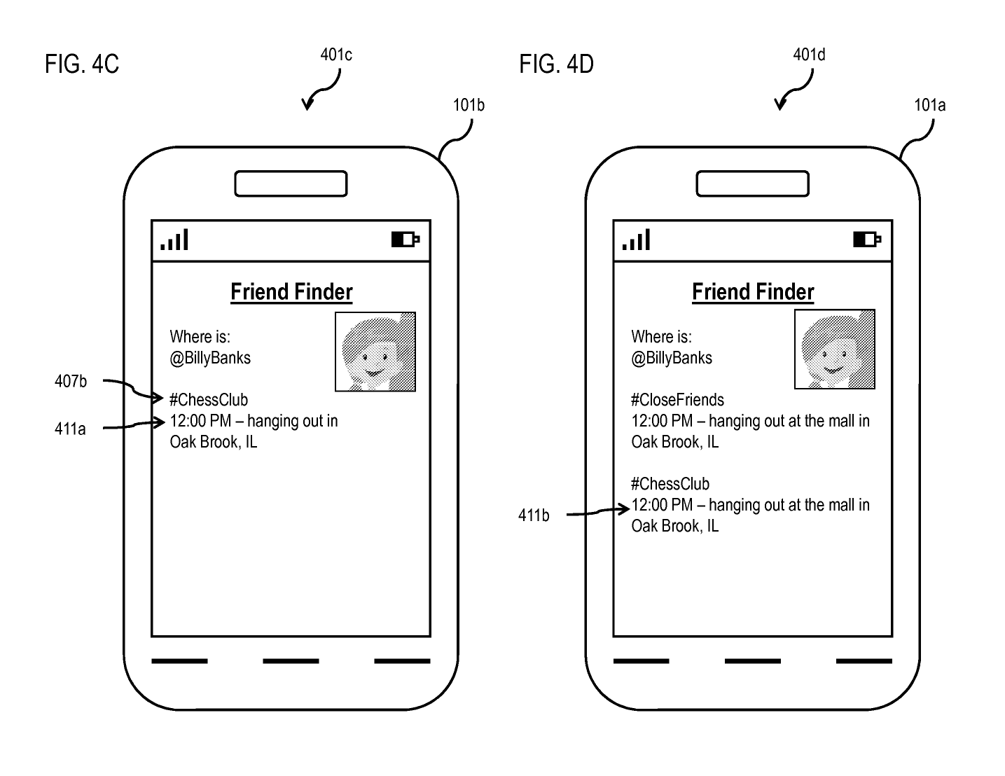

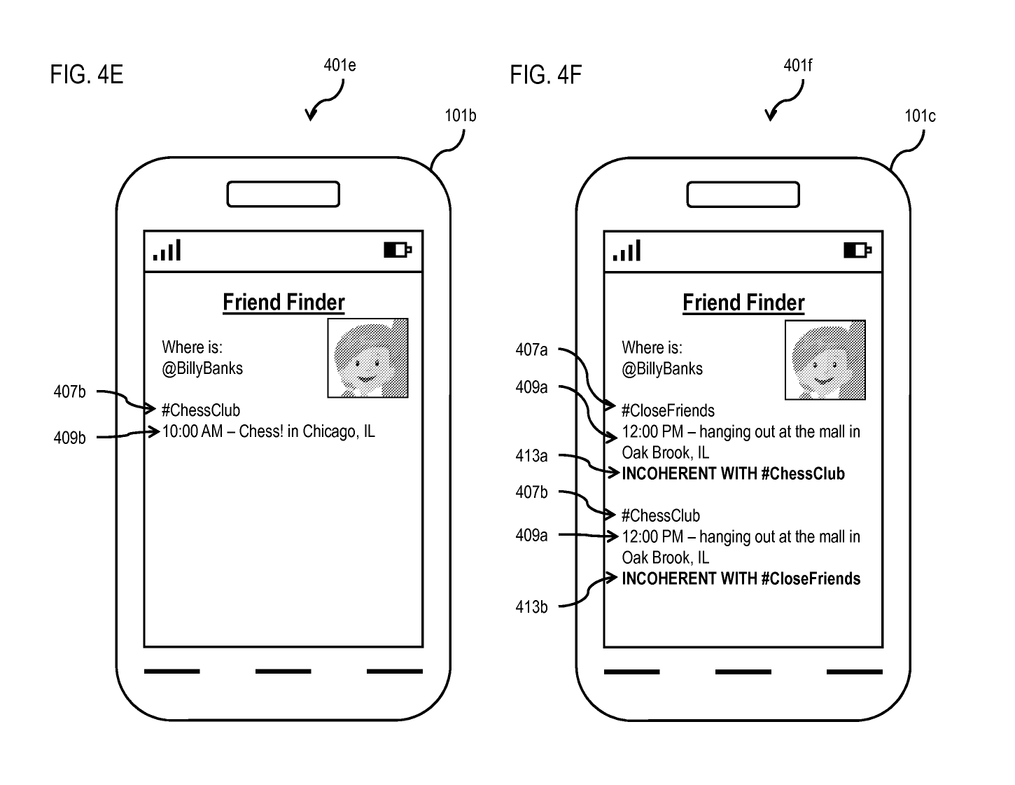

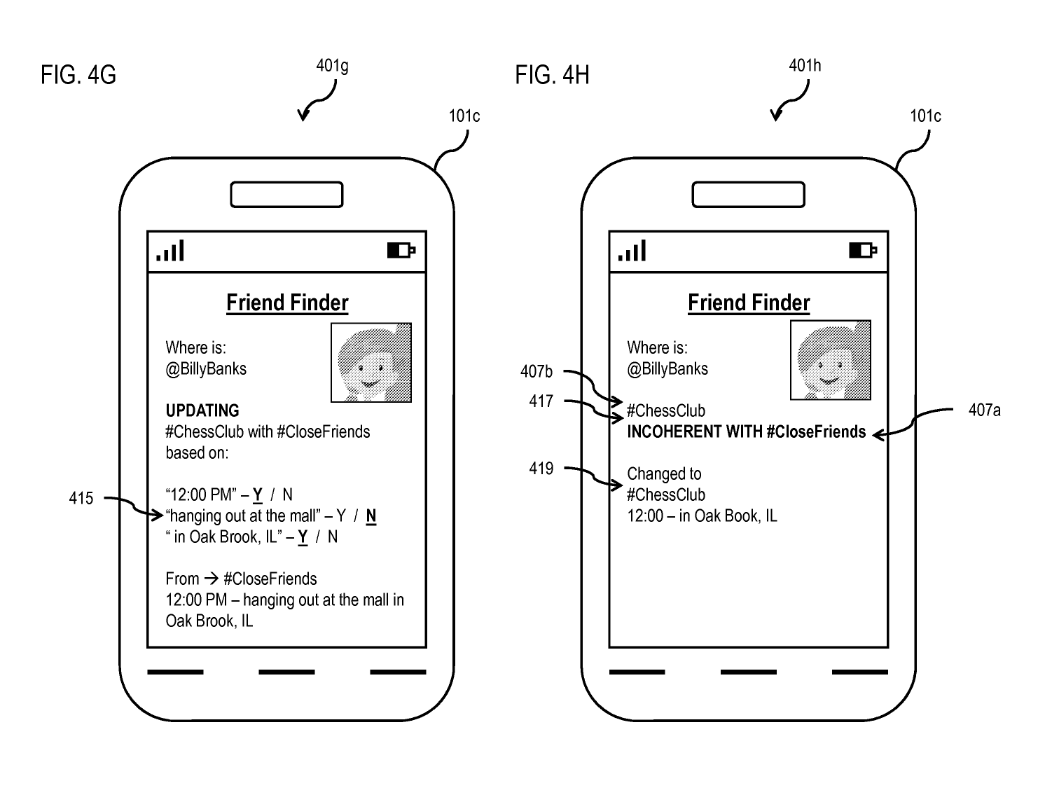

FIGS. 4A-4H are diagrams of user interfaces utilized in the processes of FIG. 3, according to various embodiments. FIG. 4A illustrates the user interface 401a of a UE 101a associated with User B that is viewing User A′s statuses on a social networking service 403. The friend has a screen name 405 associated with the social networking service 403. User A belongs to two groups 407a (#CloseFriends) and 407b (#ChessClub) within the social networking service 403. User B belongs to each of the two groups, which is why, for example, the user interface 401a of the UE 101a displays both of the two groups 407a and 407b. For each group, User A has updated his status with two data items 409a (12:00 PM—hanging out at the mall in Oak Brook, Ill.) and 409b (10:00 AM—Chess! in Chicago, Ill.), one for each one of the two groups 407a and 407b. As seen in FIG. 4A, there is an incoherency between the two data items 409a and 409b based, for example, on the time, the activity and the location.

FIG. 4B illustrates the user interface 401b of the UE 101a associated with User B of a first embodiment. FIG. 4B illustrates User B's view of User A's statuses resolved by the incoherency platform 103. As illustrated in the user interface 401b, the data item 411a for the group 407b has been resolved with the data item 409a for the group 407a. Thus, data item 411a refers to the same general location (e.g., Oak Brook, Ill.) as the data item 409b. However, the level of granularity of the data item 411a is lower than the level of granularity of the data item 409a based on the data item 411a not referring to the point of interest (e.g., the mall) as referred to in data item 409a.

FIG. 4C illustrates the user interface 401c of a UE 101b associated with User C, of the first embodiment, that is viewing the User A's status. However, the User C is only a member of the group 407b. Despite the other user being unaware of the incoherency between the data items 409a and 409b because the other user only belongs to one group, the incoherency platform 103 still modifies the data item 411a for User C because User C is at least a member of one of the two groups 407a and 407b.

FIG. 4D illustrates the user interface 401d of the UE 101a associated with User B of a second embodiment. The user interface 401d includes the data item 411b that, like data item 411a, was resolved to be coherent with the data item 409a. However, unlike FIG. 4B, the level of granularity of the data item 411b is higher than the level of granularity of the data item 411a because the data item 411b includes reference to the specific point of interest (e.g., the mall). In effect, the data item 411b is identical to the data item 407a.

FIG. 4E illustrates the user interface 401e of a UE 101b associated with User C, of the second embodiment, that is viewing the User A's status. However, in this embodiment, the incoherency platform 103 does not change the data item 409b associated with the group 407b because User C is unaware of the original incoherency between the data items 409a and 409b because User C is not a member of both groups 407a and 407b.

FIG. 4F illustrates the user interface 401f of a UE 101c associated with the user that is updating their status (e.g., User A) when the incoherency platform 103 indicates that the user has incoherent data items. As illustrated in the user interface 401f, indicators 413a and 413b indicate that the data items 409a and 409b associated with groups 407a and 407b, respectively, are incoherent. The incoherency platform 103 can display the indicators 413a and 413b upon the incoherency platform 103 determining the incoherency, such as after User A enters a data item that is incoherent with a previously entered data item, prior to sharing the subsequently entered and incoherent data item, or upon another user (e.g., User B or User C) requesting or accessing one of the two incoherent data items, as discussed above.

FIG. 4G illustrates the user interface 401g of a UE 101c associated with User A while entering resolved data item information 413. By way of example, the user interface 401g includes the prompts that constitute the resolved date item information 413 concerning, for example, the target level of granularity of the resolved data item. The user interface 401g by way of the resolved data item information allows User A to, for example, decide the information contained in the data item from which the resolved data item is based (e.g., data item 409a) to include in the resolved data item. In FIG. 4G, the options include the time (e.g., 12:00 PM), the activity (e.g., hanging out at the mall), and the location (e.g., Oak Brook, Ill.). Determining pieces of the data item 409a to include in the resolved data item allows User A to set, at least in part, the target level of granularity of the resolved data item and to further control the privacy of information contained in data items while resolving incoherencies.

FIG. 4H illustrates the user interface 401h of a UE 101c associated with User A upon being notified that a data item related to the user has been changed in response to, for example, another user viewing an incoherent data item. By way of example, the user interface 401h includes indicator 417 that informs User A of the groups 407a and 407b that contained incoherent data items. The user interface 401h also contains indicator 419 that informs User A of the resolved data item that was substituted for one or more of the incoherent data items.

The processes described herein for resolving incoherent data items of a user spanning multiple different groups and/or services may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

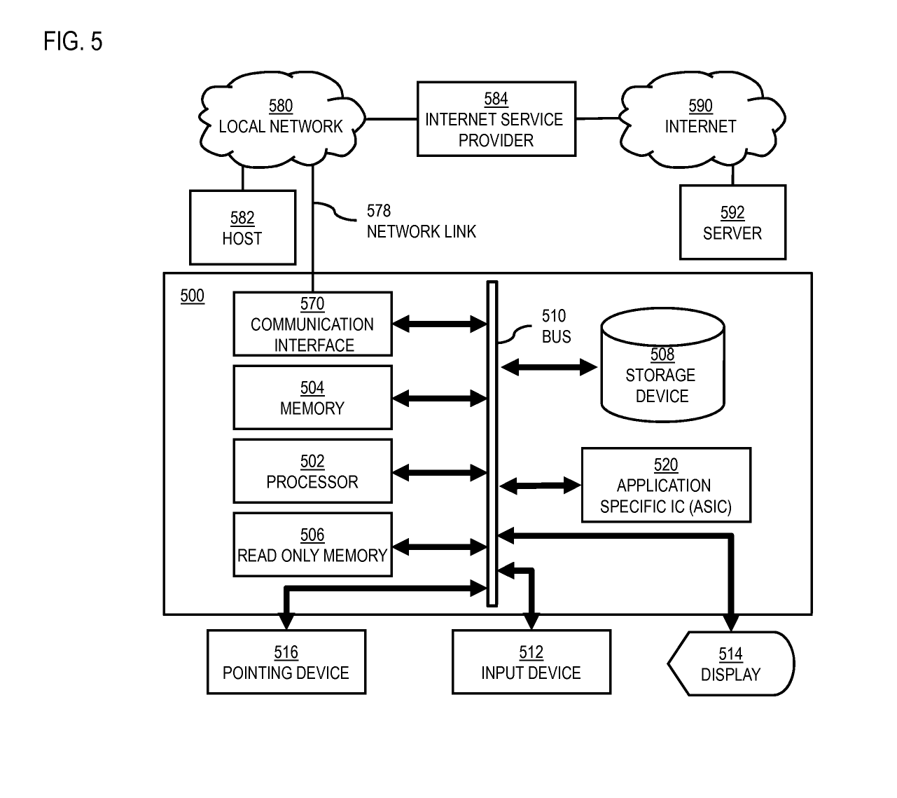

FIG. 5 illustrates a computer system 500 upon which an embodiment of the invention may be implemented. Although computer system 500 is depicted with respect to a particular device or equipment, it is contemplated that other devices or equipment (e.g., network elements, servers, etc.) within FIG. 5 can deploy the illustrated hardware and components of system 500. Computer system 500 is programmed (e.g., via computer program code or instructions) to resolve incoherent data items of a user spanning multiple different groups and/or services as described herein and includes a communication mechanism such as a bus 510 for passing information between other internal and external components of the computer system 500. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 500, or a portion thereof, constitutes a means for performing one or more steps of resolving incoherent data items of a user spanning multiple different groups and/or services.

A bus 510 includes one or more parallel conductors of information so that information is transferred quickly among devices coupled to the bus 510. One or more processors 502 for processing information are coupled with the bus 510.

A processor (or multiple processors) 502 performs a set of operations on information as specified by computer program code related to resolve incoherent data items of a user spanning multiple different groups and/or services. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 510 and placing information on the bus 510. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 502, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 500 also includes a memory 504 coupled to bus 510. The memory 504, such as a random access memory (RAM) or any other dynamic storage device, stores information including processor instructions for resolving incoherent data items of a user spanning multiple different groups and/or services. Dynamic memory allows information stored therein to be changed by the computer system 500. RAM allows a unit of information stored at a location called a memory address to be stored and retrieved independently of information at neighboring addresses. The memory 504 is also used by the processor 502 to store temporary values during execution of processor instructions. The computer system 500 also includes a read only memory (ROM) 506 or any other static storage device coupled to the bus 510 for storing static information, including instructions, that is not changed by the computer system 500. Some memory is composed of volatile storage that loses the information stored thereon when power is lost. Also coupled to bus 510 is a non-volatile (persistent) storage device 508, such as a magnetic disk, optical disk or flash card, for storing information, including instructions, that persists even when the computer system 500 is turned off or otherwise loses power.

Information, including instructions for resolving incoherent data items of a user spanning multiple different groups and/or services, is provided to the bus 510 for use by the processor from an external input device 512, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 500. Other external devices coupled to bus 510, used primarily for interacting with humans, include a display device 514, such as a cathode ray tube (CRT), a liquid crystal display (LCD), a light emitting diode (LED) display, an organic LED (OLED) display, a plasma screen, or a printer for presenting text or images, and a pointing device 516, such as a mouse, a trackball, cursor direction keys, or a motion sensor, for controlling a position of a small cursor image presented on the display 514 and issuing commands associated with graphical elements presented on the display 514. In some embodiments, for example, in embodiments in which the computer system 500 performs all functions automatically without human input, one or more of external input device 512, display device 514 and pointing device 516 is omitted.

In the illustrated embodiment, special purpose hardware, such as an application specific integrated circuit (ASIC) 520, is coupled to bus 510. The special purpose hardware is configured to perform operations not performed by processor 502 quickly enough for special purposes. Examples of ASICs include graphics accelerator cards for generating images for display 514, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 500 also includes one or more instances of a communications interface 570 coupled to bus 510. Communication interface 570 provides a one-way or two-way communication coupling to a variety of external devices that operate with their own processors, such as printers, scanners and external disks. In general the coupling is with a network link 578 that is connected to a local network 580 to which a variety of external devices with their own processors are connected. For example, communication interface 570 may be a parallel port or a serial port or a universal serial bus (USB) port on a personal computer. In some embodiments, communications interface 570 is an integrated services digital network (ISDN) card or a digital subscriber line (DSL) card or a telephone modem that provides an information communication connection to a corresponding type of telephone line. In some embodiments, a communication interface 570 is a cable modem that converts signals on bus 510 into signals for a communication connection over a coaxial cable or into optical signals for a communication connection over a fiber optic cable. As another example, communications interface 570 may be a local area network (LAN) card to provide a data communication connection to a compatible LAN, such as Ethernet. Wireless links may also be implemented. For wireless links, the communications interface 570 sends or receives or both sends and receives electrical, acoustic or electromagnetic signals, including infrared and optical signals, that carry information streams, such as digital data. For example, in wireless handheld devices, such as mobile telephones like cell phones, the communications interface 570 includes a radio band electromagnetic transmitter and receiver called a radio transceiver. In certain embodiments, the communications interface 570 enables connection to the communication network 105 for resolving incoherent data items of a user spanning multiple different groups and/or services on the UE 101.

The term “computer-readable medium” as used herein refers to any medium that participates in providing information to processor 502, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 508. Volatile media include, for example, dynamic memory 504. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 520.

Network link 578 typically provides information communication using transmission media through one or more networks to other devices that use or process the information. For example, network link 578 may provide a connection through local network 580 to a host computer 582 or to equipment 584 operated by an Internet Service Provider (ISP). ISP equipment 584 in turn provides data communication services through the public, world-wide packet-switching communication network of networks now commonly referred to as the Internet 590.

A computer called a server host 592 connected to the Internet hosts a process that provides a service in response to information received over the Internet. For example, server host 592 hosts a process that provides information representing video data for presentation at display 514. It is contemplated that the components of system 500 can be deployed in various configurations within other computer systems, e.g., host 582 and server 592.

At least some embodiments of the invention are related to the use of computer system 500 for implementing some or all of the techniques described herein. According to one embodiment of the invention, those techniques are performed by computer system 500 in response to processor 502 executing one or more sequences of one or more processor instructions contained in memory 504. Such instructions, also called computer instructions, software and program code, may be read into memory 504 from another computer-readable medium such as storage device 508 or network link 578. Execution of the sequences of instructions contained in memory 504 causes processor 502 to perform one or more of the method steps described herein. In alternative embodiments, hardware, such as ASIC 520, may be used in place of or in combination with software to implement the invention. Thus, embodiments of the invention are not limited to any specific combination of hardware and software, unless otherwise explicitly stated herein.

The signals transmitted over network link 578 and other networks through communications interface 570, carry information to and from computer system 500. Computer system 500 can send and receive information, including program code, through the networks 580, 590 among others, through network link 578 and communications interface 570. In an example using the Internet 590, a server host 592 transmits program code for a particular application, requested by a message sent from computer 500, through Internet 590, ISP equipment 584, local network 580 and communications interface 570. The received code may be executed by processor 502 as it is received, or may be stored in memory 504 or in storage device 508 or any other non-volatile storage for later execution, or both. In this manner, computer system 500 may obtain application program code in the form of signals on a carrier wave.

Various forms of computer readable media may be involved in carrying one or more sequence of instructions or data or both to processor 502 for execution. For example, instructions and data may initially be carried on a magnetic disk of a remote computer such as host 582. The remote computer loads the instructions and data into its dynamic memory and sends the instructions and data over a telephone line using a modem. A modem local to the computer system 500 receives the instructions and data on a telephone line and uses an infra-red transmitter to convert the instructions and data to a signal on an infra-red carrier wave serving as the network link 578. An infrared detector serving as communications interface 570 receives the instructions and data carried in the infrared signal and places information representing the instructions and data onto bus 510. Bus 510 carries the information to memory 504 from which processor 502 retrieves and executes the instructions using some of the data sent with the instructions. The instructions and data received in memory 504 may optionally be stored on storage device 508, either before or after execution by the processor 502.

FIG. 6 illustrates a chip set or chip 600 upon which an embodiment of the invention may be implemented. Chip set 600 is programmed to resolve incoherent data items of a user spanning multiple different groups and/or services as described herein and includes, for instance, the processor and memory components described with respect to FIG. 5 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 600 can be implemented in a single chip. It is further contemplated that in certain embodiments the chip set or chip 600 can be implemented as a single “system on a chip.” It is further contemplated that in certain embodiments a separate ASIC would not be used, for example, and that all relevant functions as disclosed herein would be performed by a processor or processors. Chip set or chip 600, or a portion thereof, constitutes a means for performing one or more steps of providing user interface navigation information associated with the availability of functions. Chip set or chip 600, or a portion thereof, constitutes a means for performing one or more steps of resolving incoherent data items of a user spanning multiple different groups and/or services.

In one embodiment, the chip set or chip 600 includes a communication mechanism such as a bus 601 for passing information among the components of the chip set 600. A processor 603 has connectivity to the bus 601 to execute instructions and process information stored in, for example, a memory 605. The processor 603 may include one or more processing cores with each core configured to perform independently. A multi-core processor enables multiprocessing within a single physical package. Examples of a multi-core processor include two, four, eight, or greater numbers of processing cores. Alternatively or in addition, the processor 603 may include one or more microprocessors configured in tandem via the bus 601 to enable independent execution of instructions, pipelining, and multithreading. The processor 603 may also be accompanied with one or more specialized components to perform certain processing functions and tasks such as one or more digital signal processors (DSP) 607, or one or more application-specific integrated circuits (ASIC) 609. A DSP 607 typically is configured to process real-world signals (e.g., sound) in real time independently of the processor 603. Similarly, an ASIC 609 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 600 includes merely one or more processors and some software and/or firmware supporting and/or relating to and/or for the one or more processors.

The processor 603 and accompanying components have connectivity to the memory 605 via the bus 601. The memory 605 includes both dynamic memory (e.g., RAM, magnetic disk, writable optical disk, etc.) and static memory (e.g., ROM, CD-ROM, etc.) for storing executable instructions that when executed perform the inventive steps described herein to resolve incoherent data items of a user spanning multiple different groups and/or services. The memory 605 also stores the data associated with or generated by the execution of the inventive steps.

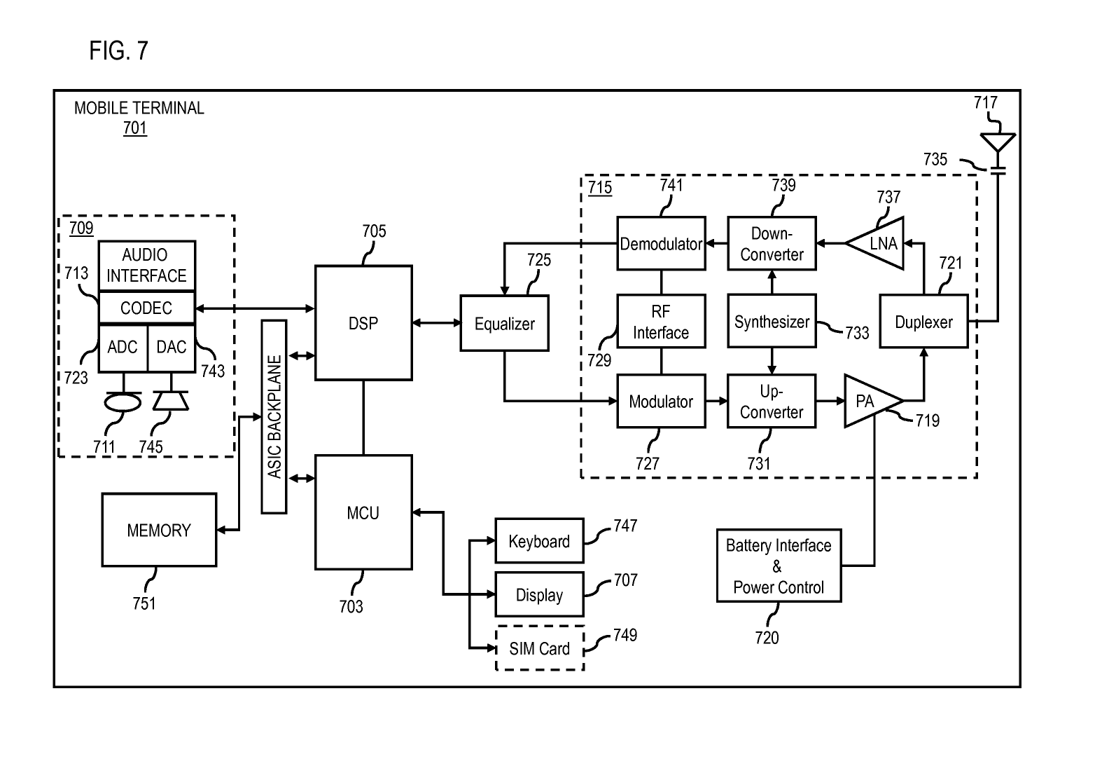

FIG. 7 is a diagram of exemplary components of a mobile terminal (e.g., handset) for communications, which is capable of operating in the system of FIG. 1, according to one embodiment. In some embodiments, mobile terminal 701, or a portion thereof, constitutes a means for performing one or more steps of resolving incoherent data items of a user spanning multiple different groups and/or services. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 703, a Digital Signal Processor (DSP) 705, and a receiver/transmitter unit including a microphone gain control unit and a speaker gain control unit. A main display unit 707 provides a display to the user in support of various applications and mobile terminal functions that perform or support the steps of resolving incoherent data items of a user spanning multiple different groups and/or services. The display 707 includes display circuitry configured to display at least a portion of a user interface of the mobile terminal (e.g., mobile telephone). Additionally, the display 707 and display circuitry are configured to facilitate user control of at least some functions of the mobile terminal. An audio function circuitry 709 includes a microphone 711 and microphone amplifier that amplifies the speech signal output from the microphone 711. The amplified speech signal output from the microphone 711 is fed to a coder/decoder (CODEC) 713.

A radio section 715 amplifies power and converts frequency in order to communicate with a base station, which is included in a mobile communication system, via antenna 717. The power amplifier (PA) 719 and the transmitter/modulation circuitry are operationally responsive to the MCU 703, with an output from the PA 719 coupled to the duplexer 721 or circulator or antenna switch, as known in the art. The PA 719 also couples to a battery interface and power control unit 720.

In use, a user of mobile terminal 701 speaks into the microphone 711 and his or her voice along with any detected background noise is converted into an analog voltage. The analog voltage is then converted into a digital signal through the Analog to Digital Converter (ADC) 723. The control unit 703 routes the digital signal into the DSP 705 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 725 for compensation of any frequency-dependent impairments that occur during transmission though the air such as phase and amplitude distortion. After equalizing the bit stream, the modulator 727 combines the signal with a RF signal generated in the RF interface 729. The modulator 727 generates a sine wave by way of frequency or phase modulation. In order to prepare the signal for transmission, an up-converter 731 combines the sine wave output from the modulator 727 with another sine wave generated by a synthesizer 733 to achieve the desired frequency of transmission. The signal is then sent through a PA 719 to increase the signal to an appropriate power level. In practical systems, the PA 719 acts as a variable gain amplifier whose gain is controlled by the DSP 705 from information received from a network base station. The signal is then filtered within the duplexer 721 and optionally sent to an antenna coupler 735 to match impedances to provide maximum power transfer. Finally, the signal is transmitted via antenna 717 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 701 are received via antenna 717 and immediately amplified by a low noise amplifier (LNA) 737. A down-converter 739 lowers the carrier frequency while the demodulator 741 strips away the RF leaving only a digital bit stream. The signal then goes through the equalizer 725 and is processed by the DSP 705. A Digital to Analog Converter (DAC) 743 converts the signal and the resulting output is transmitted to the user through the speaker 745, all under control of a Main Control Unit (MCU) 703 which can be implemented as a Central Processing Unit (CPU).

The MCU 703 receives various signals including input signals from the keyboard 747. The keyboard 747 and/or the MCU 703 in combination with other user input components (e.g., the microphone 711) comprise a user interface circuitry for managing user input. The MCU 703 runs a user interface software to facilitate user control of at least some functions of the mobile terminal 701 to resolve incoherent data items of a user spanning multiple different groups and/or services. The MCU 703 also delivers a display command and a switch command to the display 707 and to the speech output switching controller, respectively. Further, the MCU 703 exchanges information with the DSP 705 and can access an optionally incorporated SIM card 749 and a memory 751. In addition, the MCU 703 executes various control functions required of the terminal. The DSP 705 may, depending upon the implementation, perform any of a variety of conventional digital processing functions on the voice signals. Additionally, DSP 705 determines the background noise level of the local environment from the signals detected by microphone 711 and sets the gain of microphone 711 to a level selected to compensate for the natural tendency of the user of the mobile terminal 701.

The CODEC 713 includes the ADC 723 and DAC 743. The memory 751 stores various data including call incoming tone data and is capable of storing other data including music data received via, e.g., the global Internet. The software module could reside in RAM memory, flash memory, registers, or any other form of writable storage medium known in the art. The memory device 751 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 749 carries, for instance, important information, such as the cellular phone number, the carrier supplying service, subscription details, and security information. The SIM card 749 serves primarily to identify the mobile terminal 701 on a radio network. The card 749 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising facilitating a processing of and/or processing (1) data and/or (2) information and/or (3) at least one signal, the (1) data and/or (2) information and/or (3) at least one signal based, at least in part, on the following:
at least one determination that a first user and at least a second user are associated with a first group and at least a second group;
at least one determination of an incoherency of a first data item that is shared by the first user in the first group and is accessible by the at least a second user, and at least a second data item that is shared by the first user in the at least a second group and is accessible by the at least a second user; and
a processing of the incoherency, the first data item, the at least a second data item, or a combination thereof to cause, at least in part, a generation of a resolved data item.

2. A method of claim 1, wherein the (1) data and/or (2) information and/or (3) at least one signal are further based, at least in part, on the following:
a substitution of the resolved data item for the first data item, the at least a second data item, or a combination thereof.

3. A method of claim 2, wherein the substitution applies, at least in part, to the first user, the at least a second user, one or more other members of the first group, one or more other members of the second group, or a combination thereof.

4. A method of claim 1, wherein the (1) data and/or (2) information and/or (3) at least one signal are further based, at least in part, on the following:
temporal information associated with first data item and the at least a second data item; and
a processing of the temporal information to cause, at least in part, the generation of the resolved data item.

5. A method of claim 4, wherein the (1) data and/or (2) information and/or (3) at least one signal are further based, at least in part, on the following:
a processing of the temporal information to determine a most recent data item from among the first data item and the at least a second data item,
wherein the generation of the resolved data item is based, at least in part, on the most recent data item.

6. A method of claim 1, wherein the (1) data and/or (2) information and/or (3) at least one signal are further based, at least in part, on the following:
a first level of granularity of the first data item, at least a second level of granularity of the at least a second data item, or a combination thereof; and
a processing of the first level of granularity, the at least a second level of granularity, or a combination thereof to determine a target level of granularity,
wherein the generation of the resolved data item is based, at least in part, on the target level of granularity.

7. A method of claim 6, wherein the (1) data and/or (2) information and/or (3) at least one signal are further based, at least in part, on the following:
a lowest level of granularity from among the first level of granularity and the second level of granularity; and
at least one determination of the target level of granularity based, at least in part, on the lowest level of granularity.

8. A method of claim 1, wherein the (1) data and/or (2) information and/or (3) at least one signal are further based, at least in part, on the following:
at least one determination to create at least one index of the first data item, the at least a second data item, one or more other data items shared in the first group, one or more other data items shared in the at least a second group, or a combination thereof; and
a processing of the index to determine the incoherency.

9. A method of claim 1, wherein the first data item, the at least a second data item, or a combination thereof relate, at least in part, to location information, status information, profile information, or a combination thereof.

10. A method of claim 1, wherein the first group and the at least a second group are associated with different social networking services.

11. A method comprising facilitating a processing of and/or processing (1) data and/or (2) information and/or (3) at least one signal, the (1) data and/or (2) information and/or (3) at least one signal based, at least in part, on the following:
at least one determination that a user and at least one other user are associated with a first group and at least a second group;
a request from a user to share a first data item in the first group;
at least one determination of an incoherency of the first data item and at least a second data item in the at least a second group, the at least a second data item being shared by the user;
a processing of the incoherency, the first data item, the at least a second data item, or a combination thereof to cause, at least in part, a generation of a resolved data item; and
a substitution of the resolved data item with respect to, at least in part, the user for the first data item, the at least a second data item, or a combination thereof.

12. A method of claim 11, wherein the (1) data and/or (2) information and/or (3) at least one signal are further based, at least in part, on the following:
at least one determination to alert the user of the incoherency prior to sharing the first data item.

13. A method of claim 11, wherein the (1) data and/or (2) information and/or (3) at least one signal are further based, at least in part, on the following:
a prompting of the user for resolved data item information;
a processing of the resolved data item information to cause, at least in part, the generation of the resolved data item.

14. A method of claim 13, wherein the resolved data item information includes, at least in part, a target level of granularity for the resolved data item.

15. A method comprising facilitating a processing of and/or processing (1) data and/or (2) information and/or (3) at least one signal, the (1) data and/or (2) information and/or (3) at least one signal based, at least in part, on the following:
a request from a user to view a first data item in a first group, the first data item being shared by another user;
at least one determination of an incoherency of the first data item and at least a second data item in at least a second group, the at least a second data item being shared by the other user;
at least one determination of an association information of the user in the at least a second group;
a processing of the incoherency, the first data item, the at least a second data item, or a combination thereof and the association information to cause, at least in part, a generation of a resolved data item; and
a substitution of the resolved data item with respect to, at least in part, the user for the first data item, the at least a second data item, or a combination thereof.

16. A method of claim 15, wherein the (1) data and/or (2) information and/or (3) at least one signal are further based, at least in part, on the following:
a determination to notify the other user of the incoherency, the resolved data item, the substitution of the resolved data item, or a combination thereof.

17. A method of claim 15, wherein the (1) data and/or (2) information and/or (3) at least one signal are further based, at least in part, on the following:
at least one determination of a first level of granularity of the first data item, at least a second level of granularity of the at least a second data item, or a combination thereof; and
a processing of the first level of granularity, the at least a second level of granularity, or a combination thereof and the association information to determine a target level of granularity,
wherein the generation of the one or more resolved data items is based, at least in part, on the target level of granularity.

18. A method comprising facilitating a processing of and/or processing (1) data and/or (2) information and/or (3) at least one signal, the (1) data and/or (2) information and/or (3) at least one signal based, at least in part, on the following:
at least one determination of an incoherency of a first data item that is shared by a first user in a first group and at least a second data item that is shared by the first user in at least a second group;
at least one determination of association information for respective one or more other users in the first group and the at least a second group;
a processing of the incoherency, the first data item, the at least a second data item, or a combination thereof and the association information to cause, at least in part, a generation of one or more resolved data items; and
a substitution of at least one of the one or more resolved data items for the first data item, the at least a second data item, or a combination thereof for the respective one or more other users based, at least in part, on the association information.

19. A method of claim 18, wherein the (1) data and/or (2) information and/or (3) at least one signal are further based, at least in part, on the following:
at least one determination of a second user that is associated with the first group and the at least a second group, and a third user that is associated with only one of either the first group or the at least a second group; and
a determination of a first resolved data item associated with the second user and a second data item associated with the third user,
wherein the first resolved data item is different than the second resolved data item, and first resolved data item is substituted for a different one of the first data item, the at least a second data item, or a combination thereof than the second data item.

20. A method of claim 18, wherein the (1) data and/or (2) information and/or (3) at least one signal are further based, at least in part, on the following:
a determination of a first level of granularity of the first data item, at least a second level of granularity of the at least a second data item, or a combination thereof; and
a processing of the first level of granularity, the at least a second level of granularity, or a combination thereof and the association information to determine one or more target levels of granularity,
wherein the generation of the one or more resolved data items is based, at least in part, on the one or more target levels of granularity.
